(19) United States
(12) Patent Application Publication
(10) Pub. No.: US 2009/0220668 A1
(43) Pub. Date: Sep. 3, 2009

(54) CLARIFIED TEA EXTRACT AND METHOD OF MAKING SAME

(75) Inventors: Fujun Gao, Shanghai (CN); Jiang Yao, Shanghai (CN); Hongguan Xu, Shanghai (CN); Chunwei Li, Shanghai (CN); Ling Zhang, Shanghai (CN); Jian Guo Ren, Shanghai (CN)

Correspondence Address: THE COCA-COLA COMPANY;PATENT & TECHNOLOGY DEPT--NAT 19, P. O. BOX 1734, ATLANTA, GA, 30301, US

(73) Assignees: COCA-COLA CHINA BEVERAGES LTD, Shanghai (CN); THE COCA-COLA COMPANY, Atlanta, GA (US)

(21) Appl. No.: 12/040,150

(22) Filed: Feb. 29, 2008

(51) Int. Cl. A23F 3/20; A23L 1/28; A23F 3/18; A23F 3/16

(52) U.S. Cl. 426/597; 426/655; 426/435

(57) ABSTRACT

A method of making a clarified tea extract to reduce the cloudiness of a beverage containing the clarified tea extract by producing an aqueous tea extract that contains tea insolubles, adding a food-acceptable acid and a salt to the aqueous tea extract simultaneously and thereafter holding the aqueous tea extract with minimal agitation to produce a precipitate and clarifying the aqueous tea extract. Another method of making a clarified tea extract by adding a base to extraction water, contacting the base-containing extraction water with a tea source to produce an aqueous tea extract, adding a food-acceptable acid to the aqueous tea extract, and thereafter holding the aqueous tea extract with minimal agitation to produce a precipitate and clarifying the aqueous tea extract.

### TECHNICAL FIELD

The subject matter disclosed herein relates generally to beverages. More particularly, the present invention relates to beverages containing clarified tea extracts and methods of making clarified tea extracts to reduce cloudiness in the beverages during prolonged storage at ambient temperatures.

### BACKGROUND OF THE INVENTION

Aqueous tea extracts obtained from tea contain compositions, generally thought to be complexes of tea tannins and caffeine, of which some are only soluble in hot water. For example, tea tannins may contain polyphenolic compounds and complexes of polyphenolic compounds with other compounds. These cold-water insolubles are sometimes known in the art as “tea creams.” Consequently, beverages containing conventionally prepared tea extracts often become cloudy as the beverage temperature decreases towards ambient temperature or below due to the precipitation of these tea insolubles. The appearance and taste of cloudy beverages are often unacceptable to customers.

One approach of solving the clouding problem is to precipitate out the insoluble complexes by lowering the temperature of the tea extract. U.S. Pat. No. 4,797,293 describes a process wherein a tea extract is prepared by lowering the pH to between 2.9 and 3.5, chilling the extract to between −1.1° C. to 7.2° C., and clarifying the extract to remove the precipitate. However, the method requires cooling the tea extract significantly below room temperature, which may increase the energy costs of production and may also require incorporation of additional equipments into existing production lines. Thus, there remains a need for a method of producing a clarified tea extract without substantially altering the organoleptic properties of the tea extract and which can be readily incorporated into current production lines.

### SUMMARY OF THE INVENTION

To reduce cloudiness of a tea extract, embodiments encompassed by the present disclosure provide a method of making a clarified tea extract comprising producing an aqueous tea extract that contains tea insolubles, adding at least one food-acceptable acid to the aqueous tea extract, adding at least one salt to the aqueous tea extract, and thereafter holding the aqueous tea extract with minimal agitation to produce a precipitate and clarifying the aqueous tea extract to obtain the clarified tea extract. In a particular embodiment, the at least one food-acceptable acid and the at least one salt are added to the aqueous tea extract substantially simultaneously.

Embodiments of the present disclosure also encompass a method of making a clarified tea extract comprising adding a base to extraction water, contacting the base-containing extraction water with at least one tea source to produce an aqueous tea extract, wherein the aqueous tea extract contains tea insolubles, adding at least one food-acceptable acid to the aqueous tea extract, and thereafter holding the aqueous tea extract with minimal agitation to produce a precipitate and clarifying the aqueous tea extract to obtain the clarified tea extract.

To reduce cloudiness of a tea extract, the present disclosure also encompass embodiments that provide a method of making a clarified tea extract comprising adding a base to extraction water, contacting the base-containing water with at least one tea source to produce an aqueous tea extract that contains tea insolubles, adding at least one food-acceptable acid to the aqueous tea extract, adding at least one salt to the aqueous tea extract, and thereafter holding the aqueous tea extract with minimal agitation to produce a precipitate and clarifying the aqueous tea extract to obtain the clarified tea extract. In a particular embodiment, the at least one food-acceptable acid and the at least one salt are added to the aqueous tea extract substantially simultaneously.

Embodiments of the present invention also encompass a clarified tea extract produced by the aforementioned methods and beverages comprising the clarified tea extract.

Other objects, features, and advantages of this invention will be apparent from the following detailed description and claims.

### DETAILED DESCRIPTION OF THE INVENTION

As used herein, the term “food-acceptable acid” is understood to mean any acid that is safe for human or animal consumption. The term “minimal agitation” is understood to mean little or no agitation. The term “tea source” is understood to mean tea leaf materials that may be in, but are not limited to, the forms of a concentrate, powder, liquid, or leaves. The term “extraction water” is understood to mean the water that contacts the tea source to obtain an aqueous tea extract. The water used in the present invention may include, but is not limited to, distilled water and deionized water. Any disclosed range is understood to include any sub-range within the disclosed range limits.

As summarized above, embodiments of the present invention encompass a method for making a clarified tea extract by producing an aqueous tea extract that contains tea insolubles, adding at least one food-acceptable acid and at least one salt to the aqueous tea extract, and thereafter clarifying the aqueous tea extract to obtain the clarified tea extract. The aqueous tea extract containing tea insolubles may be obtained through various methods. Some examples may include, but are not limited to, obtaining the aqueous tea extract by contacting tea leaf materials with extraction water or by dissolving dried tea powder in the extraction water.

Embodiments of the present invention also encompass a method for producing a clarified tea extract by adding a base to the extraction water, contacting the base-containing water with at least one tea source to produce an aqueous tea extract containing tea insolubles, adding at least one food-acceptable acid to the aqueous tea extract, and thereafter clarifying the aqueous tea extract to obtain the clarified tea extract.

Embodiments of the present invention also encompass another method for producing a clarified tea extract by adding a base to the extraction water, contacting the base-containing water with at least one tea source to produce an aqueous tea extract containing tea insolubles, adding at least one food-acceptable acid and at least one salt to the aqueous tea extract, and thereafter clarifying the aqueous tea extract to obtain the clarified tea extract.

In some embodiments, the aqueous tea extract may be held with minimal agitation to produce a precipitate before the clarifying step. In other embodiments, the holding time with minimal agitation may be for at least about 30 minutes. Typically, the longer the holding time, the more completed the precipitation process. However, too long of a holding time may be ineffective given the time restraints of product manufacturing. Optimum holding times of the present invention may be dependent on certain factors including but not limited to production time, product volume, and quality demands.

Wherein extraction water is used in the present invention, the tea source to extraction water w/w ratio may be between about 1:5 to about 1:100 or about 1:20 to about 1:60. According to some embodiments, the extraction water temperature may be at least about 55° C. In other embodiments, the extraction water temperature may be between about 85° C. to about 100° C., but without boiling the water. The aqueous tea extract may be cooled before adding the food-acceptable acid. In particular embodiments, the temperature of the aqueous tea extract may be reduced to below about 30° C. before adding the food-acceptable acid. In still more particular embodiments, the aqueous tea extract may be chilled to a temperature below about 20° C. and even below about 15° C. before adding the food-acceptable acid. According to other embodiments, the aqueous tea extract may be filtered before the addition of the food-acceptable acid.

According to some embodiments of the present invention, the food-acceptable acid may be selected from a group consisting of citric acid, phosphoric acid, tannic acid, hydrochloric acid, malic acid, tartaric acid, lactic acid, formic acid, ascorbic acid, isoascorbic acid, sulfuric acid, fumaric acid, adipic acid, and mixtures thereof. In other embodiments, the food-acceptable acid may be added to the aqueous tea extract in an amount sufficient to yield a pH between about 2.0 to about 4.5 or between about 2.5 to about 4.2 or between about 2.7 to about 3.5. In some embodiments, the pH may be held constant while varying amounts of salt or base are added to the aqueous tea extract. Without being bound by theory, it is believed that acidic conditions promote agglomeration of the tea insolubles, thereby forming complexes that more readily precipitate out of the aqueous tea extract. The lower the pH, the greater the precipitation of the tea insolubles is expected. However, reducing the pH of the aqueous tea extract to lower than about 2.0 may impart undesirable flavors or characteristics to the clarified tea extract and subsequently to the beverage that contains the clarified tea extract. Furthermore, subsequent adjustment of the pH may be necessary if the beverage requires a more neutral tea extract.

Wherein a salt is used in the present invention, the salt may be added to the aqueous tea extract before filtration. In other embodiments, the salt may be added before cooling the aqueous tea extract. According to particular embodiments of the invention, the salt may be added to the aqueous tea extract substantially simultaneously with the addition of the food-acceptable acid. In other embodiments, the salt may be added followed by the subsequent addition of the food-acceptable acid. In still other embodiments, the food-acceptable acid may be added followed by the subsequent addition of the salt. Without being bound by theory, it is believed that the salt further exaggerates the agglomeration and precipitation effects of the acid by promoting the formation of tea solid complexes that more readily precipitate out of the aqueous tea extract and/or by neutralizing tea insolubles to produce insoluble complexes that more readily precipitate out of the aqueous tea extract. The combined use of the food-acceptable acid and the salt may also have other chemical effects that promote the precipitation of tea insolubles, depending on the structure, polarity, and other characteristics of the complexes in the aqueous tea extract.

According to some embodiments of the invention, the salt may comprise at least an anion selected from the group consisting of chloride, carbonate, sulfate, acetate, bicarbonate, citrate, phosphate, hydrogen phosphate, tartrate, sorbate and mixtures thereof. More particularly, the salt may be selected from the group consisting of sodium citrate, potassium citrate, sodium chloride, potassium chloride, sodium phosphate, potassium phosphate, and sodium sulfate. In some embodiments, the salt may be added to the aqueous tea extract in an amount sufficient to promote formation of the precipitate by speeding up the formation of the precipitate and/or increasing the amount of insolubles. The “amount sufficient” is understood to mean the amount necessary to reduce the turbidity value (NTU) by at least about 10%. According to some embodiments, the salt may be sodium chloride and the sodium chloride may be added to the aqueous tea extract in an amount no less than about 0.8 g NaCl/kg tea source but no more than about 320 g NaCl/kg tea source. In more particular embodiments, sodium chloride may be added in an amount between about 4 g NaCl/kg tea source to about 160 g NaCl/kg of tea source. In still more particular embodiments, sodium chloride may be added in an amount between about 20 g NaCl/kg tea source to about 40 g NaCl/kg tea source. In other embodiments, the salt may be potassium citrate and the potassium citrate may be added to the aqueous tea extract in an amount no less than about 8 g K₃C₆O₇H₅/kg tea source but no more than about 600 g K₃C₆O₇H₅/kg tea source. In more particular embodiments, potassium citrate may be added in an amount between about 20 g K₃C₆O₇H₅/kg tea source to about 300 g K₃C₆O₇H₅/kg of tea source. In other embodiments, the salt may be sodium citrate and the sodium citrate may be added to the aqueous tea extract in an amount no less than about 8 g Na₃C₆O₇H₅/kg tea source but no more than about 160 g Na₃C₆O₇H₅/kg tea source. In some embodiments, the salt may be sodium phosphate and the sodium citrate may be added to the aqueous tea extract in an amount between about 8 g Na₃PO₄/kg tea source to about 320 g Na₃PO₄/kg of tea source. In other embodiments, the salt may be potassium chloride and the potassium chloride may be added to the aqueous tea extract in an amount between about 5.6 g KCl/kg tea source to about 200 g KCl/kg of tea source.

Wherein a base is used in the present invention, the base may be added to the water before contacting the extraction water with the tea leaves. In other embodiments, the extraction water may first contact the tea leaves before the addition of the base to the aqueous tea extract. Without being bound by theory, it is believed that the addition of the base to the extraction water enhances the oxidation of polyphenols in the aqueous tea extract, thereby promoting the formation of complexes that can more readily precipitate out of the aqueous tea extract. According to some embodiments, the base may be selected from a group consisting of sodium carbonate, sodium bicarbonate, potassium carbonate, potassium bicarbonate and mixtures thereof. In some embodiments, the base is added to the extraction water in an amount sufficient to yield a pH between about 4.5 to about 8.0 or between about 5.0 to about 7.5 and even between about 5.0 to about 6.5, prior to the addition of the at least one food-acceptable acid. According to particular embodiments, the base may be sodium bicarbonate and the sodium bicarbonate may be added to the extraction water in an amount no less than about 0.8 g NaHCO₃/kg tea source but no more than about 80 g NaHCO₃/kg tea source. In more particular embodiments, the sodium bicarbonate may be added in an amount between about 4 g NaHCO₃/kg tea source to about 64 g NaHCO₃/kg tea source.

The aqueous tea extract may be clarified by various methods including but not limited to decanting, filtration, or centrifugation alone or in combination. According to some embodiments of the present invention, the aqueous tea extract may be clarified by using a centrifuge to remove the precipitate of tea insolubles and to obtain the clarified tea extract. The clarified tea extract may then be used to produce beverages using conventional methods. Alternatively, the clarified tea extract may be processed into liquid (beverage or concentrate) or powder form, which may then be used to produce beverages. Embodiments of the present invention also encompass clarified tea extracts produced by the aforementioned methods and beverages comprising such clarified tea extracts.

The present invention may be applicable, but is not limited, to fermented tea, unfermented tea, partially fermented tea, and mixtures thereof. Some examples of tea include, but are not limited to, black tea, green tea, and oolong tea.

Beverages containing the clarified tea extracts of the present invention may include, but are not limited to, juice beverages, carbonated beverages, nutritional beverages, and other tea-containing beverages. “Tea-containing beverages” are understood to mean any beverage containing more than 0 g of water-soluble tea components per liter of water. Beverages containing the clarified tea extracts of the present invention may also contain other components typical to beverages, including but not limited to preservatives, sweeteners, nutritional components, and flavoring agents.

### EXAMPLES

The invention may be further illustrated by the following examples, which are not to be construed in any way as imposing limitations on the scope thereof. On the contrary, it is to be clearly understood that resort may be had to various other embodiments, modifications, and equivalents thereof which, after reading the description herein, may suggestion themselves to those skilled in the art without departing from the spirit of the present invention and/or scope of the appended claims.

### Example I

A clarified tea extract was prepared as follows: Heating about 5,760 g of deionized water to about 90° C. and adding the water to a stainless steel container that contained about 192 g of black tea. (The tea leaves to water w/w ratio was 1:30.) The container was moved to a water bath with a temperature between about 89° C. to about 91° C. The mixture was slowly stirred for about 10 minutes and then filtered by a 200-300 mesh filter to separate the aqueous tea extract from the tea residues. The aqueous tea extract was then chilled to below about 15° C. using an ice water bath and divided into five samples. Each sample was added with the same amount of citric acid but a different amount of sodium chloride as described in Table 1. The samples were stirred for homogeneity and then held with minimal agitation for about 30 minutes at about 15° C. Each sample was then clarified using a centrifuge at a speed of 4000 rpm for three minutes to obtain a clarified tea extract. The pH and turbidity value were then again measured at about 20° C. and recorded in Table 1. The turbidity value is measured using the Merck Tubiquant 1500T and the measurement unit of NTU (Nephelometric Turbidity Unit).

TABLE 1
(Tea Leaves to Water w/w Ratio: 1:30)

| | NaCl Added | | Turbidity |
|---|---|---|---|
| Sample # | (g NaCl/kg tea leaves) | pH | (NTU) |
| 1 | 0 | 2.85 | 719 |
| 2 | 4 | 2.88 | 595 |
| 3 | 8 | 2.87 | 435 |
| 4 | 20 | 2.80 | 350 |
| 5 | 160 | 2.67 | 55 |

### Example II

A clarified tea extract was prepared using the same procedure as Example I, except the tea leaves to water ratio is about 1:20 and the pH of the aqueous tea extract was adjusted by varying amounts of citric acid to about 2.5. The turbidity after centrifugation at a speed of 4000 rpm for three minutes was measured at about 20° C. and recorded in Table 2.

TABLE 2
(Tea Leaves to Water w/w Ratio: 1:20; pH = 2.5)

| | NaCl Added | |
|---|---|---|
| Sample # | (g NaCl/kg tea leaves) | Turbidity (NTU) |
| 1 | 0 | 439 |
| 2 | 4 | 78.4 |
| 3 | 160 | 24.9 |

### Example III

A clarified tea extract was prepared using the same procedure as Example II, except sodium phosphate was added instead of sodium chloride was in the amounts specified in Table 3. The turbidity after centrifugation at a speed of 4000 rpm for three minutes was measured at about 20° C. and recorded in Table 3.

TABLE 3
(Tea Leaves to Water w/w Ratio: 1:20; pH = 2.5)

| | Na₃PO₄ Added | Turbidity |
|---|---|---|
| Sample # | (g Na₃PO₄/kg tea leaves) | (NTU) |
| 1 | 0 | 539 |
| 2 | 320 | 24.9 |

The same procedure was repeated with the tea leaves to water ratio at about 1:50 and with a pH of about 2.9 adjusted by varying amounts of citric acid. The turbidity after centrifugation at a speed of 4000 rpm for three minutes was measured at about 20° C. and recorded in Table 3.

TABLE 4
(Tea Leaves to Water w/w Ratio: 1:50; pH = 2.9)

| | Na₃PO₄ Added | Turbidity |
|---|---|---|
| Sample # | (g Na₃PO₄/kg tea leaves) | (NTU) |
| 1 | 0 | 396 |
| 2 | 32 | 38.7 |
| 3 | 320 | 8.61 |

### Example IV

A clarified tea extract was prepared using the same procedure as Example I. Different salts were added to the aqueous tea extract in the amounts specified in Table 5. The tea leaves to water ratio was about 1:30 and the pH of the aqueous tea extract was adjusted by varying amounts of citric acid to about 2.9. The turbidity after centrifugation at a speed of 4000 rpm for three minutes was measured at about 20° C. and recorded in Table 5.

TABLE 5
(Tea Leaves to Water w/w Ratio: 1:30; pH = 2.9)

| | | Salt Added | |
|---|---|---|---|
| | | (g Salt/kg | Turbidity |
| Sample # | Salt | tea leaves) | (NTU) |
| 1 | None | 0 | 538 |
| 2 | Sodium Chloride | 32 | 393 |
| 3 | Sodium Chloride | 320 | 55 |
| 4 | Potassium Chloride | 5.6 | 358 |

The results indicate that the all the different salts had some effect on reducing the cloudiness of the clarified tea extract. The optimum salt amount necessary to achieve the lowest turbidity depends on the particular salt used.

### Example V

A clarified tea extract was prepared as follows: Heating about 6,000 g of deionized water to about 90° C. and dividing the water to five separate stainless steel containers, each containing about 40 g of black tea. Each sample was added with different amounts of sodium bicarbonate as listed in Table 6. All containers were moved to water baths with a temperature between about 89° C. to about 91° C. The mixture was slowly stirred for about 10 minutes and then filtered by a 200-300 mesh filter to separate the aqueous tea extract from the tea residues. Each sample of the aqueous tea extract was then chilled using an ice water bath and tested for pH and turbidity values at about 20° C. The data is shown in Table 6 (1^{st} Measurement). The aqueous tea extract was then continuously chilled to below about 15° C. The same amount of citric acid was then added to each sample, which was then stirred for homogeneity. The samples were held with minimal agitation for 30 minutes at about 15° C. Each sample was then clarified using a centrifuge at a speed of 4000 rpm for three minutes. The pH and turbidity were again measured at about 20° C. with the results shown in Table 6 (2^{nd} Measurement).

TABLE 6

| Sample | NaHCO₃ Added | | | Turbidity |
|---|---|---|---|---|
| # | (g NaHCO₃/kg tea leaves) | Measurement # | pH | (NTU) |
| 1 | 0 | 1 | 4.86 | 432 |
| | 0 | 2 | 2.85 | 719 |
| 2 | 4 | 1 | 5.09 | 230 |
| | 4 | 2 | 2.96 | 292 |
| 3 | 8 | 1 | 5.38 | 188 |
| | 8 | 2 | 2.88 | 122 |
| 4 | 16 | 1 | 6.0 | 118 |
| | 16 | 2 | 3.09 | 14 |
| 5 | 80 | 1 | 7.36 | 156 |
| | 80 | 2 | 4.1 | 241 |

The results indicate that the optimum sodium bicarbonate amount to achieve the lowest turbidity may be between about 4 g NaHCO₃/kg tea leaves to about 16 g NaHCO₃/kg tea leaves, which correspond to a 1^{st} Measurement pH value between about 5.0 to about 6.1.

### Example VI

A tea extract was prepared as follows: Heating about 2,400 g of deionized water to about 90° C. adding the water to stainless steel container that contains about 40 g of black tea. About 0.32 g of sodium bicarbonate was also added to the container. The container was then moved to water baths with a temperature between about 89° C. to about 91° C. The mixture was slowly stirred for about 10 minutes and then filtered by a 200-300 mesh filter to separate the aqueous tea extract from the tea residues. The aqueous tea extract was then chilled to below about 15° C. using an ice water bath and divided into two samples. The same amount of citric acid was then added to each sample to adjust the pH to about 2.9. About 0.6 g of sodium chloride was only added to sample 2. Both samples were stirred for homogeneity and held with minimal agitation for 30 minutes at about 15° C. Each sample was then clarified using a centrifuge at a speed of 4000 rpm for three minutes. The turbidity was again measured at about 20° C. with the results shown in Table 7.

TABLE 7

| | NaCl Added | Turbidity |
|---|---|---|
| Sample # | (g NaCl/kg tea leaves) | (NTU) |
| 1 | 0 | 36.9 |
| 2 | 20 | 15 |

The results indicate that the combined use of the sodium bicarbonate in the extraction water and the sodium chloride in the acidification process helps to reduce turbidity even more than the use of sodium bicarbonate or of sodium chloride alone.

1. A method of making a clarified tea extract comprising:
a) producing an aqueous tea extract comprising tea insolubles;
b) adding at least one food-acceptable acid to the aqueous tea extract;
c) adding at least one salt to the aqueous tea extract;
d) thereafter, holding the aqueous tea extract with minimal agitation to produce a precipitate; and
e) thereafter, clarifying the aqueous tea extract to obtain the clarified tea extract.

2. The method of claim 1, wherein the aqueous tea extract is produced by contacting extraction water with at least one tea source and wherein the extraction water is at a temperature of at least about 55° C.

3. The method of claim 2, further comprising filtering the aqueous tea extract and reducing the temperature of the aqueous tea extract to below about 30° C. before step (b).

4. The method of claim 1, wherein steps (b) and (c) occur substantially simultaneously.

5. The method of claim 1, wherein steps (b) and (c) occur consecutively one after the other.

6. The method of claim 1, wherein the at least one salt may comprise at least one anion selected from the group consisting of chloride, carbonate, sulfate, acetate, bicarbonate, citrate, phosphate, hydrogen phosphate, tartrate, sorbate and mixtures thereof.

7. The method of claim 6, wherein the at least one salt is added to the aqueous tea extract in an amount sufficient to promote formation of the precipitate.

8. The method of claim 1, wherein the at least one salt is sodium chloride and the sodium chloride is added to the aqueous tea extract at about 0.8 g NaCl/kg tea source to about 320 g NaCl/kg tea source.

9. The method of claim 1, wherein the at least one food-acceptable acid is selected from the group consisting of citric acid, phosphoric acid, tannic acid, hydrochloric acid, malic acid, tartaric acid, lactic acid, formic acid, ascorbic acid, isoascorbic acid, sulfuric acid, fumaric acid, adipic acid, and mixtures thereof

10. The method of claim 9, wherein the at least one food-acceptable acid is added to produce an aqueous tea extract with a pH between about 2.0 and about 4.5.

11. The method of claim 1, wherein the aqueous tea extract is held for at least 30 minutes at step (d).

12. The clarified tea extract produced by the method of claim 1.

13. A beverage comprising the clarified tea extract of claim 12.

14. A method of making a clarified tea extract comprising
a) adding at least one base to extraction water;
b) contacting the base-containing extraction water with at least one tea source to produce an aqueous tea extract, wherein the aqueous tea extract contains tea insolubles;
c) adding at least one food-acceptable acid to the aqueous tea extract;
d) thereafter holding the aqueous tea extract with minimal agitation to produce a precipitate; and
e) thereafter clarifying the aqueous tea extract to obtain the clarified tea extract.

15. The method of claim 14, wherein the extraction water is at a temperature of at least about 55° C.

16. The method of claim 14, wherein the at least one base is selected from the group consisting of sodium carbonate, sodium bicarbonate, potassium carbonate, potassium bicarbonate and mixtures thereof.

17. The method of claim 14, wherein the at least one base is sodium bicarbonate and the sodium bicarbonate is added to the extraction water at about 0.8 g NaHCO₃/kg tea source to about 80 g NaHCO₃/kg tea source.

18. The method of claim 14, wherein the at least one base is added to the extraction water to produce an aqueous tea extract with a pH between about 4.5 and about 8.0 prior to the addition of the at least one food-acceptable acid.

19. The method of claim 14, wherein the at least one food-acceptable acid is added in an amount sufficient to produce an aqueous tea extract with a pH between about 2.0 and about 4.5.

20. The method of claim 14, wherein the aqueous tea extract is held for at least 30 minutes at step (d).

21. The clarified tea extract produced by the method of claim 14.

22. A beverage comprising the clarified tea extract of claims 21.

23. A method of making a clarified tea extract comprising
a) adding a base to extraction water;
b) contacting the base-containing extraction water with at least one tea source to produce an aqueous tea extract, wherein the aqueous tea extract contains tea insolubles;
c) adding at least one food-acceptable acid to the aqueous tea extract;
d) adding at least one salt to the aqueous tea extract;
e) thereafter holding the aqueous tea extract with minimal agitation to produce a precipitate; and
f) thereafter clarifying the aqueous tea extract to obtain the clarified tea extract.

24. The method of claim 23, wherein steps (c) and (d) occur substantially simultaneously.

25. The method of claim 23, wherein steps (c) and (d) occur consecutively one after the other.

26. The method of claim 23, wherein the at least one salt is sodium chloride and the sodium chloride is added to the aqueous tea extract at about 0.8 g NaCl/kg tea source to about 320 g NaCl/kg tea source.

27. The method of claim 23, wherein the at least one base is sodium bicarbonate and the sodium bicarbonate is added to the extraction water at about 0.8 g NaHCO₃/kg tea source to about 80 g NaHCO₃/kg tea source.

28. The method of claim 23, wherein the at least one base is added to the extraction water to produce an aqueous tea extract with a pH between about 4.5 and about 8.0 prior to the addition of the at least one food-acceptable acid.

29. The method of claim 23, wherein the at least one food-acceptable acid is added to produce an aqueous tea extract with a pH between about 2.0 and about 4.5.

30. The clarified tea extract produced by the method of claim 23.

31. A beverage comprising the clarified tea extract of claims 30.
